(19) United States
(12) Patent Application Publication
(10) Pub. No.: US 2003/0018518 A1
(43) Pub. Date: Jan. 23, 2003

(54) Management system for balance of reserve accounts for a repairing apartment house

(76) Inventors: Yuichi Ikeda, Mito (JP); Hiroshi Shojima, Hitachiota (JP); Yoshiaki Usami, Hitachi (JP); Masanori Miyoshi, Mito (JP)

Correspondence Address: HOGAN & HARTSON L.L.P., 500 S. GRAND AVENUE, SUITE 1900, LOS ANGELES, CA, 90071-2611, US

(21) Appl. No.: 10/102,597

(22) Filed: Mar. 18, 2002

(30) Foreign Application Priority Data
Jul. 18, 2001 (JP) 2001-218071

(51) Int. Cl. G06F 17/60

(52) U.S. Cl. 705/10; 705/38

(57) ABSTRACT

A transmitter-receiver 11 accepts delinquency information indicating a delinquent situation of a repairing reserve to be paid by a comparted owner of an apartment house from a financial institution terminal 3. On the basis of the delinquency information, a delinquency rate forecasting unit 21 forecasts an average delinquency rate and its standard deviation. A marginal stress searching unit 20 calculates a cumulative reserve and calculates a marginal stress under a constraint that a cumulative reserve is not below an expenditure. A less marginal probability calculating unit 21 calculates a probability of the marginal stress or less. A permissible risk checking unit 18 checks whether or not its probability is within a tolerance range, and a revised amount calculating unit 17 revises a repairing reserve amount if the probability is beyond the tolerance range.

### BACKGROUND OF THE INVENTION

The present invention relates to a technique for managing a risk in collecting a repairing reserve for an apartment house, and more particularly to a technique for managing a collection risk in collecting the repairing reserves expediently so that a necessary budget is obtained at an expected time by practicing a repairing plan for an apartment house.

In managing an apartment house, a caretaker union is organized by the comparted owners to maintain and manage a whole building. The caretaker union scarcely ever fulfills an actual management and has no special knowledge for making a management business over various fields. In most cases, the caretaker union entrusts the management to a management company that is a special dealer.

In maintaining the apartment house, a fund is usually reserved for large repairs that are required aside from daily minute repairs. This fund is called a repairing reserve. Repairing expenses for daily minute repairs are paid from a management cost. However, it is common that the repairing expenses for large repairs made after a certain period, such as elevator replacement and repair of outer wall, are reserved as the repairing reserve aside from the management cost.

The above management business and administration are conducted by a qualified person called a management business director or a comparted ownership administrator. Herein, the management business director is a qualified person as defined in the middle or high rise joint housing management dealer registered rules (Notification No. 1115 of the Ministry of Construction, 1986). The comparted ownership administrator is a qualification that is defined independently and approved by the high-rise housing management association for mansion management unions. A standard apartment house management in the present state of affairs is described in detail in “Mansion Management Revolution” (Shoich Nakajima, Kodansha), and “Business Practice Know-how for Mansion Management Union” (Hideki Kawata, Nippon Jitugyo Publishing).

However, the apartment housing management heretofore has no scheme for controlling the collection of the repairing reserves. For instance, due to a difference of how to treat the assets value of the apartment house caused by the age or family make-up of the comparted owner, the repairing reserve may not be paid. At this time, there is no effective measure taken.

Also, it is not possible to grasp quantitatively whether a necessary amount of money is sufficiently met by the repairing reserves at present to effect a large repairing work scheduled in the future.

### BRIEF SUMMARY OF THE INVENTION

It is an object of the present invention to provide a technique for managing the balance of a repairing reserve without excess and deficiency.

In order to attain the above object, the present invention comprises acquiring delinquency information indicating a delinquent status of a repairing reserve to be paid by a comparted owner of an apartment house, forecasting a probability distribution of delinquency rate on the basis of the delinquency information, forecasting the balance of repairing reserves on the basis of the probability distribution and expected expenditures, and judging whether or not the balance of the repairing reserves is within a predetermined proper range.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram of a network system containing a repairing reserve collection risk management system according to an embodiment of the present invention;

FIG. 2 is an explanatory diagram showing time series of interactions at the time of selling a new apartment house in lots;

FIG. 3 is an explanatory diagram showing the time series of interactions at an ordinary time;

FIG. 4 is an explanatory diagram showing the time series of interactions when a sudden damage occurs;

FIG. 5 is an explanatory diagram showing the time series of interactions at the time of selling an exclusive portion of the apartment house;

FIG. 6 is a view showing one example of a menu screen 22;

FIG. 7 is a flowchart showing an examination procedure at the time of purchase;

FIG. 8 is a view showing one example of an examination screen 22;

FIG. 9 is a view showing one example of a reserve changing disclosure screen 24;

FIG. 10 is a view showing one example of a delinquency information disclosure screen 25;

FIG. 11 is a flowchart showing a collecting procedure of the delinquency information;

FIG. 12 is a flowchart showing a procedure for pressing a delinquent for payment;

FIG. 13 is a flowchart showing a processing procedure when a sudden damage occurs;

FIG. 14 is a view showing one example of a sudden damage situation input screen 26;

FIG. 15 is a view showing one example of a financial possibility and amount of money screen 27;

FIG. 16 is a view showing one example of a financing amount of money and repayment schedule plan screen 28;

FIG. 17 is a flowchart showing a processing procedure at the time of selling an exclusive portion;

FIG. 18 is a view showing one example of an exclusive portion selling screen 29;

FIG. 19 is a graphical representation showing a calculation result of a marginal stress;

FIG. 20 is a first graph showing the calculation result of a reserve update time and amount of money;

FIG. 21 is a second graph showing the calculation result of the reserve update time and amount of money;

FIG. 22 is a third graph showing the calculation result of the reserve update time and amount of money; and

FIG. 23 is a fourth graph showing the calculation result of the reserve update time and amount of money.

### BRIEF DESCRIPTION OF EMBODIMENTS OF THE INVENTION

The preferred embodiments of the present invention will be described below with reference to the accompanying drawings.

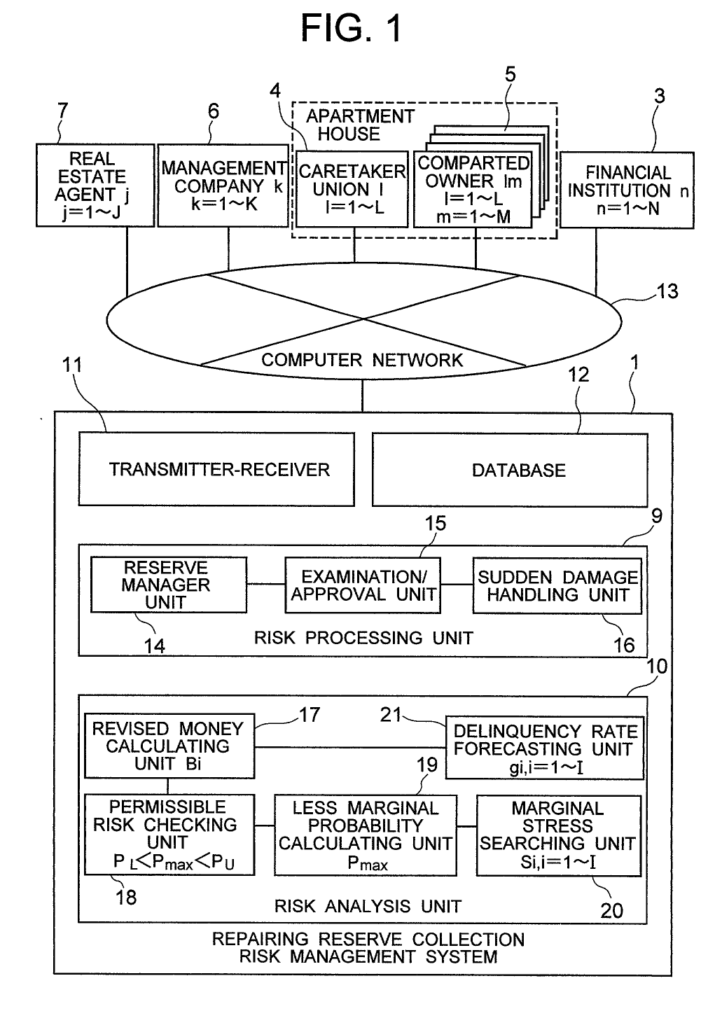

First of fall, FIG. 1 shows a configuration of a network system including a repairing reserve collection risk management system according to an embodiment of the invention. A repairing reserve collection risk management system 1 is connected via a network 13 to a plurality of comparted owner terminals 5 in apartment houses, a plurality of caretaker union terminals 4 for the apartment houses, a plurality of management company terminals 6, a plurality of real estate agency terminals 7, and a plurality of financial institution terminals 3. The system and the terminals connected to the network each have a function of intercommunication capability.

The repairing reserve collection risk management system (hereinafter referred to as a main system) 1 has a transmitter-receiver 11, a database 12, a risk processing unit 9, and a risk analysis unit 10. The transmitter-receiver 11 supplies the information for displaying a menu screen 22 upon a request from each terminal. Furthermore, the transmitter-receiver 11 transmits or receivers the data to or from the devices connected to the network. The database 12 stores the personal information of a comparted owner or a customer.

The risk processing unit 9 comprises a reserve manager 14, an examination/approval unit 15 and a sudden damage handling unit 16.

The reserve manager 14 manages the collection situation of repairing reserves. For instance, the reserve manager 14 creates a list of delinquents, and makes a process of pressing the delinquent for payment.

The examination/approval unit 15 makes the examination for an intending purchaser of the apartment house, and approves the purchase if the predetermined conditions are met.

The sudden damage handling unit 16 makes a process for receiving a finance from a caretaker union not suffered when a sudden damage such as the earthquake occurs.

The risk analysis unit 10 comprises a delinquency rate forecasting unit 21, a marginal stress searching unit 20, a less marginal probability calculating unit 19, a permissible risk inspecting unit 18, and a revised amount calculating unit 17.

The delinquency rate forecasting unit 21 forecasts a probability distribution of a delinquency rate on the basis of delinquency information indicating a delinquent status.

The marginal stress searching unit 20 searches the marginal stress that maximizes the cumulative arrearage that is an objective function under the predetermined constraints.

The less marginal probability calculating unit 19 calculates the probability of the marginal stress obtained by the marginal stress searching unit 20 or below.

The permissible risk inspecting unit 18 determines whether or not the probability Pₘₐₓ of the marginal stress or below obtained by the less marginal probability calculating unit 19 is within a predetermined permissible risk range. Also, the permissible risk inspecting unit 18 forecasts the time till the probability Pₘₐₓ is out of the permissible risk range.

The revised amount calculating unit 17 changes the repairing reserve so that the probability Pₘₐₓ is contained within the permissible risk range, if the probability Pₘₐₓ is out of the permissible risk range, as a result of determination by the permissible risk inspecting unit 18.

Several specific instances of the risk management will be set forth below.

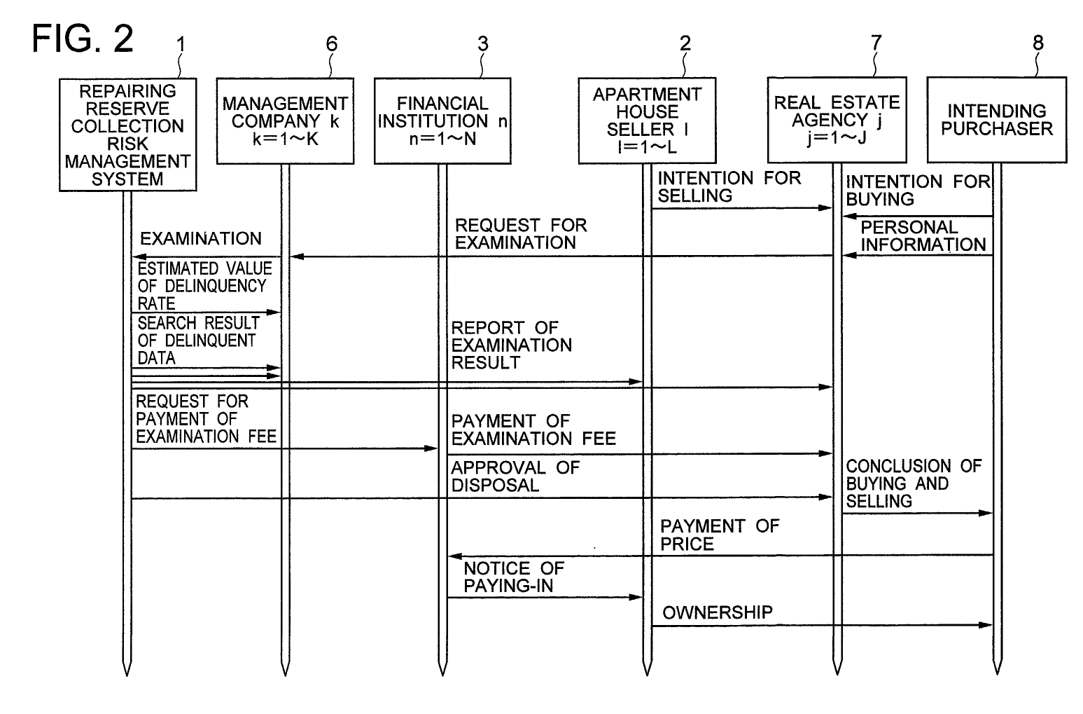

The risk management in selling a new apartment house in lots will be discussed in accordance with the time series of interactions in selling the new apartment house in lots, as shown in FIG. 2.

A vendor of apartment house tells an intention for selling to a real estate agent. An intending purchaser appears in the business activities of the real estate agent, and tells an intention for purchase to the real estate agent. The real estate agent receives the personal information needed for examination from the intending purchaser, and asks a management company to examine the intending purchaser with its personal information. Herein, it is supposed that the management company is in charge of an input operation of the personal information into the repairing reserve collection risk management system 1, but alternatively, the real estate agency may be in charge of that input operation.

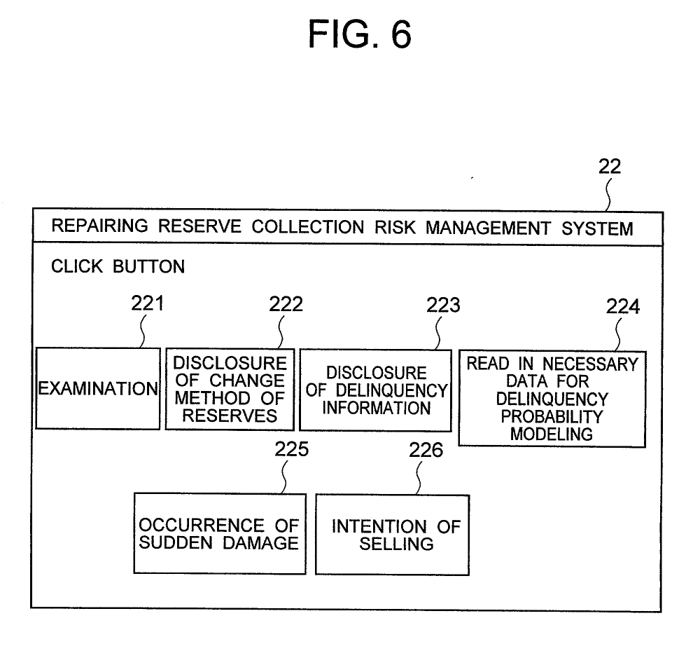

In the case where the management company terminal 6 is connected through the computer network 13 to the repairing reserve collection risk management system 1, the a menu screen 22 of FIG. 6 appears after confirmation of a password. The menu screen 22 has the buttons of examination 221, reserve changing disclosure 222, delinquency information disclosure 223, data reading 224, sudden damage occurrence 225, and selling intention 226. If a button of examination 221 is clicked, a process is passed to the examination/approval unit 15. If the examination/approval unit 15 ends the predetermined processing, the menu screen 22 waits for a click on the button again.

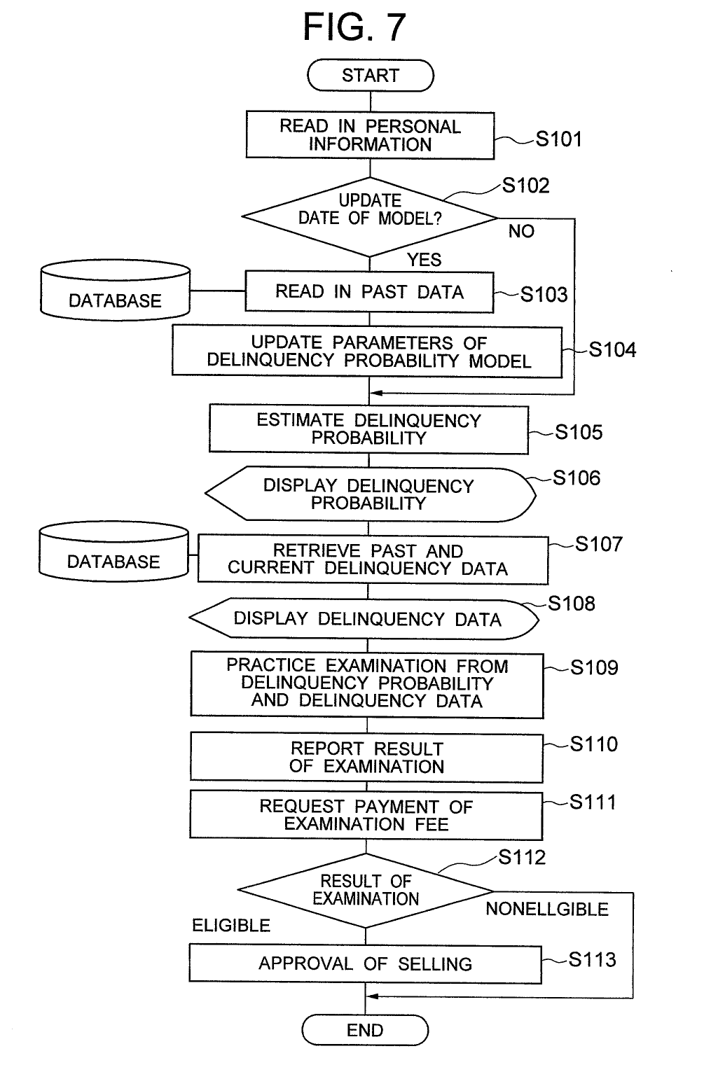

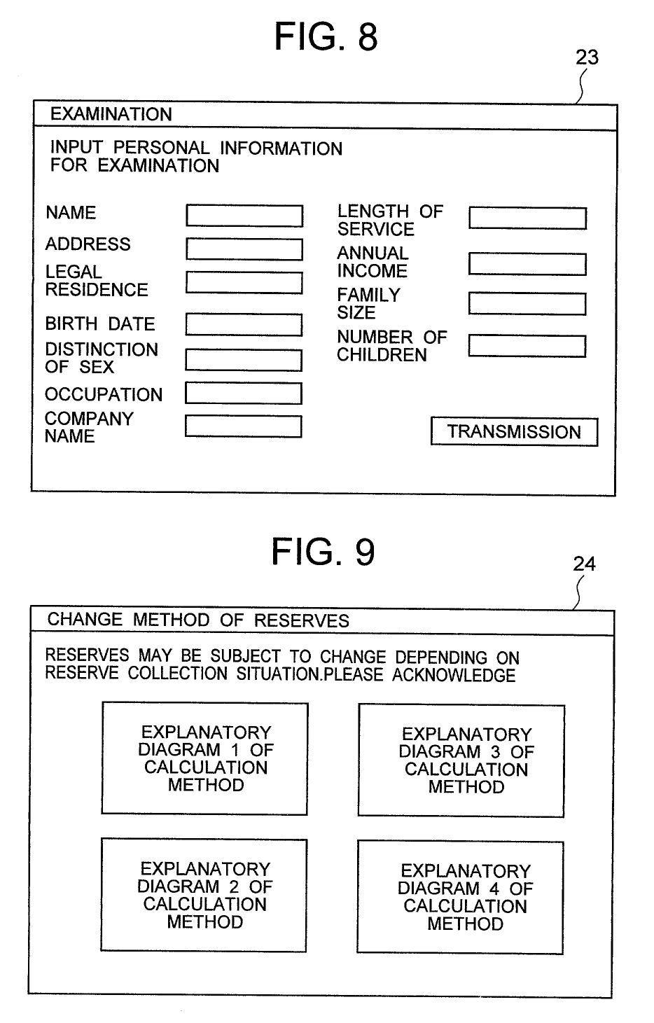

The examination/approval unit 15 displays an examination screen 23 as shown in FIG. 8. The examination screen 23 has an input area for inputting the personal information of the intending purchaser to be examined. The examination process will be described below in accordance with a processing flowchart as shown in FIG. 7.

The examination/approval unit 15 reads the personal information input from the examination screen 22 (S101). Then, the examination/approval unit 15 determines whether or not it is a model update day of the delinquency probability (S102). In case of the model update day, the necessary data is read from the database 12 and the model parameters are updated (S103, S104). And the examination/approval unit 15 estimates the probability that the intending purchaser fails to pay the repairing reserves in the future, using a statistical model, and displays the result on the display screen (S105, S106).

Then, the examination/approval unit 15 retrieves the past and current delinquency data of the intending purchaser 8 from the database 12 and displays the result on the display screen (S107, S108). If the intending purchaser 8 has a delinquency history at another apartment house in the past, it is apparent from this process.

If the estimated delinquency probability is less than a threshold value set up by the operator of the main system 1, and there is no delinquency history, the intending purchaser is examined to be eligible, or otherwise, the intending purchaser is examined to be non-eligible (S109). The result of examination is reported to the management company, the vendor, and the real estate agent (S110). Thereafter, if the main system 1 issues a request for payment of an examination fee to the financial institution terminal 3, the examination fee is transferred from an account of the vendor 2 to an account of the real estate agent 7 (S111).

The real estate agency can acquire the sale approval only if the examination result is eligible, and sell an exclusive portion of the apartment house to the intending purchaser (S112, S113). In this way, providing that the delinquency probability is estimated using the statistical model, and a list of comparted owners being delinquent at present and a list of comparted owners delinquent in the past are created in the database, the intending purchaser who is judged to become possibly delinquent during the period of owning the exclusive portion is not allowed to be sold.

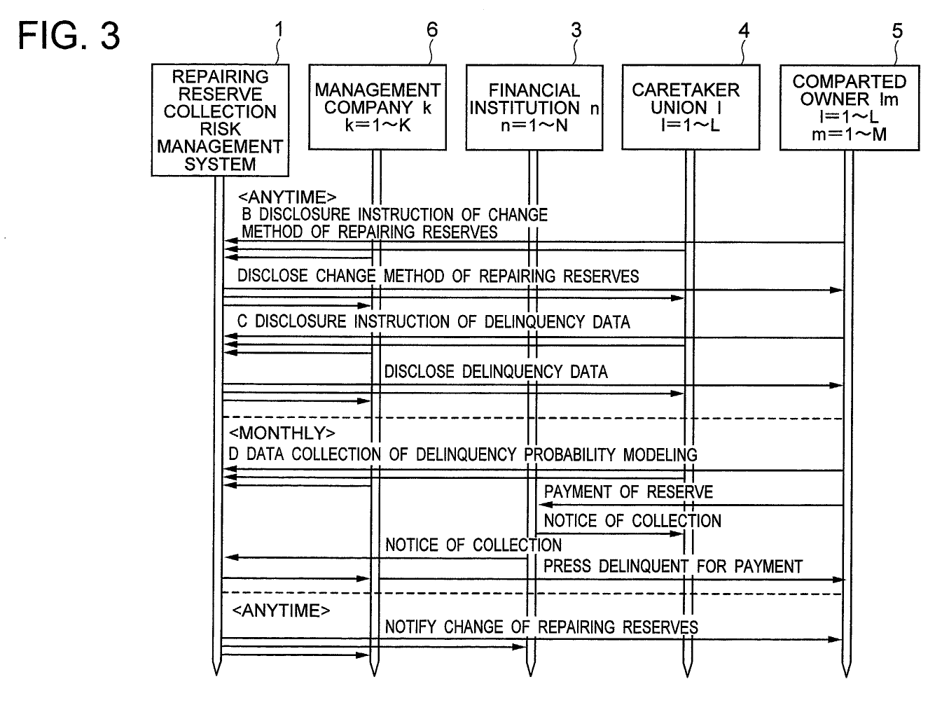

The delinquency risk management for repairing reserves at the ordinary time will be described below in accordance with the time series of interactions at the ordinary time as shown in FIG. 3. Herein, the ordinary time means a situation where the repairing reserves are collected in accordance with a schedule, except for selling a new apartment house in lots, a sudden damage due to an earthquake etc., and the resale of exclusive portion or the like.

At the ordinary time, the change term of repairing reserves and the amount of reserve after change are decided using the repairing reserve collection risk management system 1. Furthermore, a method of deciding the change term of repairing reserves and the reserves after change can be disclosed at any time upon a request from the comparted owner terminal 5.

Herein, a reserve collection method changing disclosure will be described below. When the comparted owner terminal 5 is connected through the computer network 13 to the repairing reserve collection risk management system 1, the menu screen 22 is displayed, after confirmation of a password. If a reserve changing method disclosure button 222 is clicked, a reserve changing method disclosure screen 24 of FIG. 9 is displayed. The disclosure screen 24 displays the diagrams for explaining a method of calculating the probability that the marginal stress and less marginal stress situations occur and the method of deciding the change term of repairing reserves and reserves after change, as will be described later. By disclosing the method of deciding the change term of repairing reserves and the reserves after change, the comparted owner 5 can understand that the change process is objective and rational.

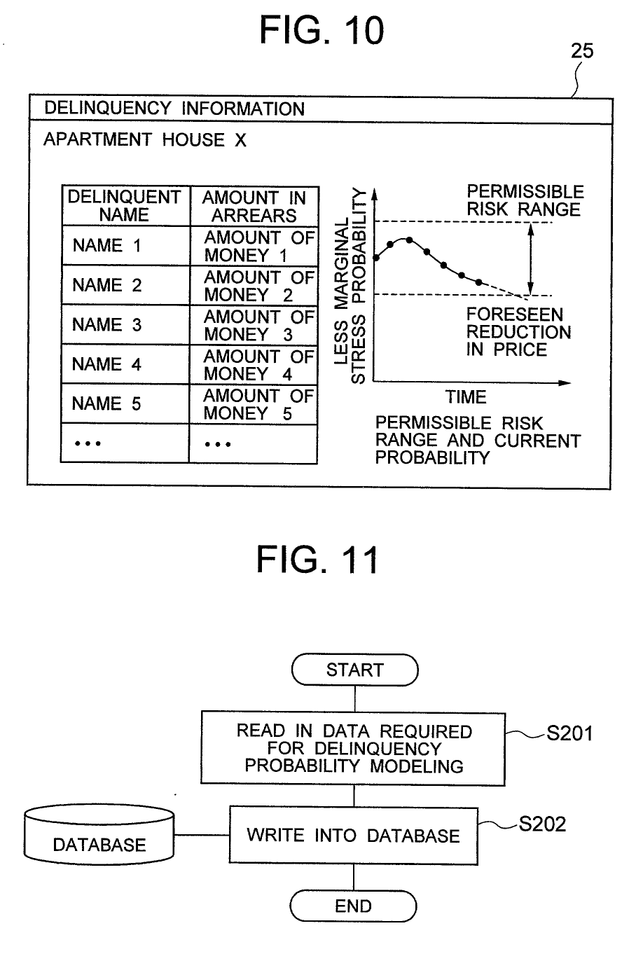

If a delinquency information disclosure button 223 is clicked on the menu screen 22, a delinquency information disclosure screen 25 of FIG. 10 is displayed. The disclosure screen 25 includes a name of mansion where the comparted owner 5 lives, a list of delinquents and amounts in arrears, the probability of marginal stress or less and a diagram of permissible risk, as will be described later. In the case where the comparted owner terminal 5 is connected through the computer network 13 to the repairing reserve collection risk management system 1, the password is confirmed, whereby it is possible to disclose the information regarding the list of delinquents and the delinquent status to the limited addresses for the privacy protection of the comparted owner.

The data collection required for the delinquency probability modeling will be described below. This data collection may be made at a predetermined day every month, for example. A procedure for collecting the delinquency data is shown in FIG. 11.

The delinquency data required for the delinquency probability modeling is acquired from the financial institution terminal 3, and the caretaker union terminal 4 or the comparted owner terminal 5, and written into the database 12 (S201, S202). The data acquired from the financial institution terminal 3 indicates the presence or absence of delinquency in repairing reserves of each comparted owner. The data acquired from the caretaker union terminal 4 or the comparted owner terminal 5 is the personal information of each comparted owner. Herein, the personal information may be acquired in advance. The personal information has the same contents as those used for the examination as shown in FIG. 8, but must be updated by the comparted owner or caretaker union, when a job site or family make-up is changed. In this way, if the comparted owner belongs to a population that is subjected to the statistical analysis, the data required for the delinquency probability modeling can be collected effectively.

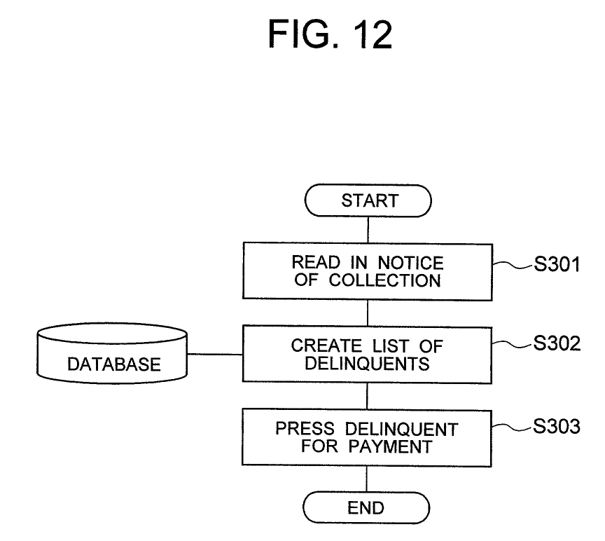

For collecting the repairing reserves at a predetermined day every month, a notice of collection may be sent to the caretaker union 4 and the main system 1 at a stage where the financial institution terminal 3 confirms the collection. In this main system 1, the reserve manager 14 performs a procedure of pressing for payment in accordance with a flowchart as shown in FIG. 12. That is, the reserve manager 14 reads the data of the notice of collection (S301). The reserve manager 14 creates a list of delinquents on the basis of the data of the notice of collection (S302). The list of delinquents is written into the database and a process for pressing the delinquent for payment is performed (S303).

The change of repairing reserves and the decision of the amount of reserve after change will be described below. The repairing reserves may be changed by judging the necessity after the repairing reserves are collected every month, or may be made anytime.

To judge whether or not to change the amount of reserve, a cash flow for collecting the repairing reserves is formulated as a linear programming problem to find a limitative state where the cash flow stands under the constraints, or the marginal stress. An objective function z is defined as a sum of arrearages di to have an index representing the unhealthiness of cash flow.

Numerical expression 1

$$z = {\sum }_{i = 1}^{n} {d}_{i} \qquad ( 1 )$$

Numerical expression 2

dᵢ=(gᵢ+Sᵢσᵢ)(Bᵢ−Bᵢ)≅(gᵢ+Sᵢσᵢ)Bᵢ (2)

Where n is a repairing reserve collection term (months), Si is a delinquency stress in the i-th term, Bi is a collected repairing reserve initially foreseen in the i-th term, gi is a delinquency rate in the i-th term, σi is the standard deviation in the i-th term, and βi is a reduction in reserves due to delinquency occurring before the i-th term. Because the delinquency rate gi and its standard deviation σi require a term structure, the delinquency rate forecasting unit 21 makes the modeling, employing a proportional hazard model. Also, βi in the expression (2) is a reduction in reserves due to delinquency occurring before the i-th term, and can be represented as a sum of terms proportional to the delinquency rates before the i-th term. Accordingly, the reduction in reserves βi due to delinquency is proportional to the delinquency rate to the second power and a contribution to di is so small as to be negligible.

The cash flow in each term stands. That is, the constraint that the actual reserves do not fall below predetermined expenditure can be given by the following expression.

Numerical expression 3

$${\sum }_{i = 1}^{j} ( {v}_{i} - {\sum }_{k = 1}^{i} \frac{{d}_{k}}{n - k + l} - {f}_{i} ) {( l + \frac{r}{12} )}^{j - i} \geq {δ}_{jn} F \\ ( j = 1 , 2 , … , n ) \qquad ( 3 )$$

Where vi is a collection repairing reserve initially foreseen in the i-th term, fi is a maintenance cost paid in the i-th term, and F is a collection repairing the reserves for each month are enforced as the safety assets at an annual rater.

Further, the stress Si is also subjected to the constraint.

0≦Si≦3 (i=1, 2, Λ, n) (4)

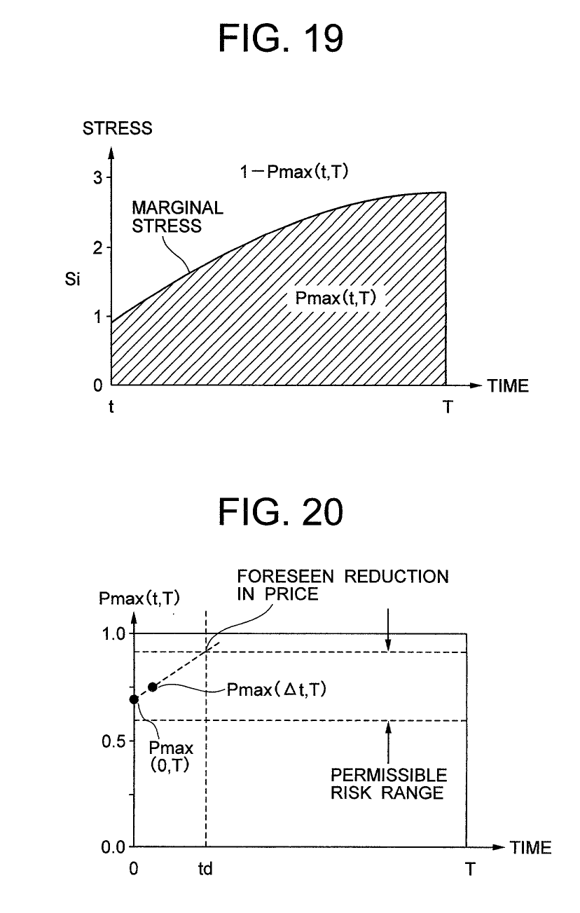

Under the above constraints (3) and (4), the marginal stress searching unit 20 maximizes the objective function, whereby the marginal stress Si is calculated. FIG. 19 shows a calculation result of marginal stress.

Further, the less marginal probability calculating unit 19 calculates the probability that the situation of less marginal stress occurs by obtaining the area of slash portion of FIG. 19.

Numerical expression 4

$${P}_{max} ( t , T ) = \frac{{\int }_{t}^{T} P ( x \leq l ( s ) ) ⅆ s}{{\int }_{t}^{T} l ⅆ s} = \frac{1}{T} {\int }_{t}^{T} P ( x \leq l ( s ) ) ⅆ s \qquad ( 5 )$$

Numerical expression 5

$$P ( x \leq l ( t ) ) = \frac{2}{σ \sqrt{2 π}} {\int }_{0}^{l} exp [ - {( x - μ )}^{2} / 2 {σ}^{2} ] ⅆ x \qquad ( 6 )$$

Where the mean value is μ={gi; i=1, Λ, n} and the marginal stress is l={gi+Siσi; i=1, Λ, n}. Accordingly, the probability that there is a severer situation than the marginal stress is equal to 1-Pₘₐₓ.

Further, a method of revising the repairing reserve at any time so that the probability Pₘₐₓ remains within the set permissible risk range will be described below with reference to FIGS. 20 to 23. FIGS. 20 to 23 show the change of Pₘₐₓ with respect to the time. And the permissible range as the probability Pₘₐₓ is predetermined as the permissible risk range. The permissible risk checking unit 18 monitors whether or not the probability Pₘₐₓ is within the permissible risk range.

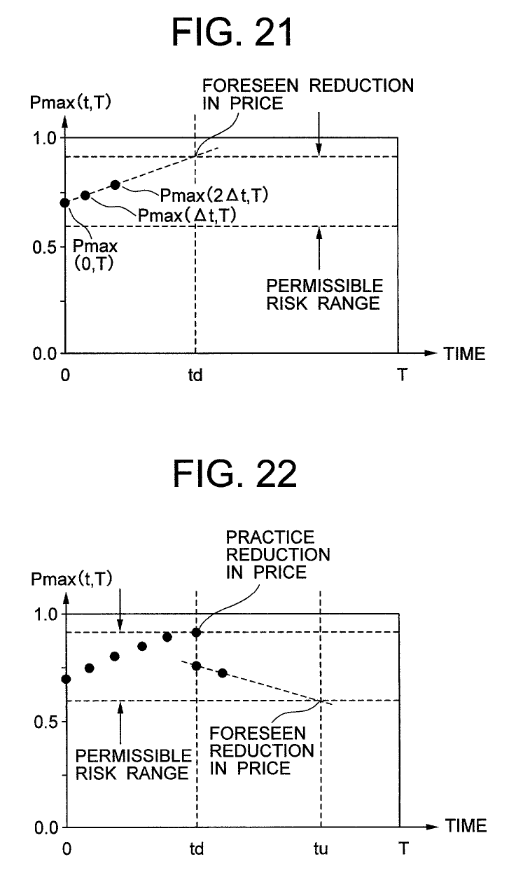

When the probability Pₘₐₓ reaches an upper limit of the permissible risk, it means that a safety margin takes too much. At this time, the revised amount calculating unit 17 reduces the price so that the probability Pₘₐₓ is equal to a median in the permissible risk range. FIG. 20 shows a locus of the probability Pₘₐₓ at t=Δt. The permissible risk checking unit 18 forecasts a price reduction scheduled time td with a linear extrapolation using two probabilities Pₘₐₓ. FIG. 21 shows a locus of the probability Pₘₐₓ at the next time step t=2Δt. The permissible risk checking unit 18 forecasts a price reduction scheduled time td with a linear extrapolation using two probabilities Pₘₐₓ, namely, Pₘₐₓ (Δt, T) and Pₘₐₓ (2Δt, T)

Though various methods of forecasting the scheduled time td are considered, the simplest method involves the linear extrapolation using two probabilities Pₘₐₓ. Even if any forecasting method is employed, the forecasted value of the scheduled time td is varied slightly at each time step. Hence, the forecasted value is persistently a yardstick.

In FIG. 22, if the permissible risk checking unit 18 detects that the probability Pₘₐₓ reaches an upper limit of the permissible risk, the revised amount calculating unit 17 reduces the price so that the probability Pₘₐₓ is equal to a median in the permissible risk range. Furthermore, the permissible risk checking unit 18 forecasts the price rise scheduled time tu from Pₘₐₓ (td, T) and Pₘₐₓ (td+Δt, T). If the permissible risk checking unit 18 detects that the probability Pₘₐₓ reaches a lower limit of the permissible risk, the revised amount calculating unit 17 reduces the price so that the probability Pₘₐₓ is equal to a median in the permissible risk range.

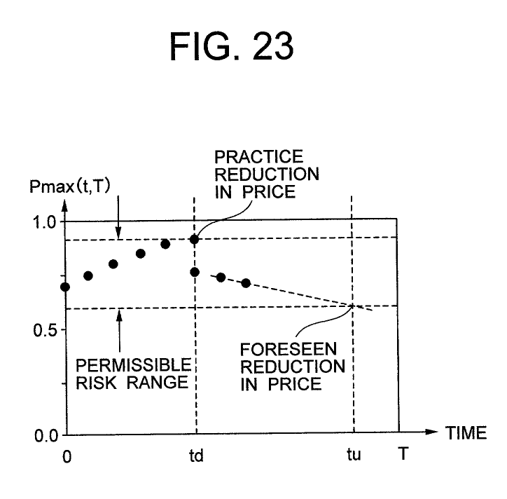

It will be seen, from a locus of the probability Pₘₐₓ as shown in FIG. 23, that the forecast of the price rise scheduled time tu is varied like the forecast of the price reduction scheduled time td. By repeating the above procedure till the revised scheduled time T, the risk is controlled so that the probability Pₘₐₓ draws a locus within the permissible risk range, while forecasting the next price rise/price reduction scheduled time.

With the above method, the probability that the marginal stress and the less marginal stress occurs can be calculated effectively. Furthermore, the change time of repairing reserves and the amount of reserves after change can be decided effectively.

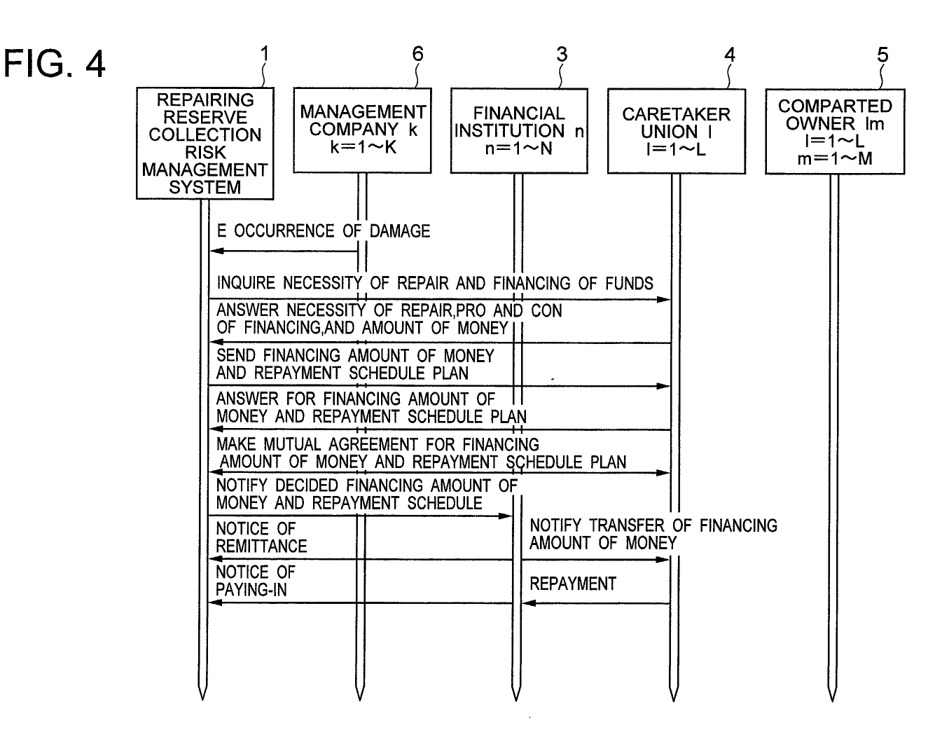

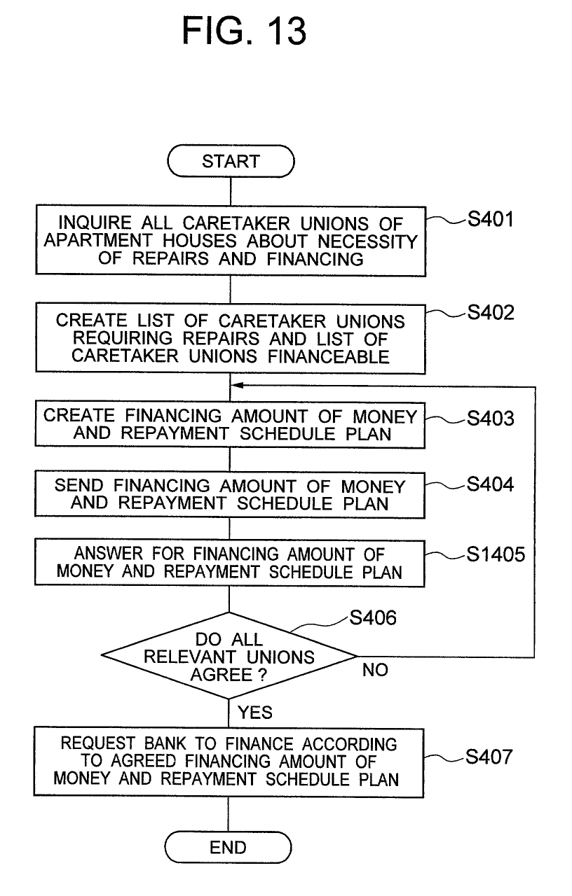

The risk management when a sudden damage such as an earthquake or the like occurs will be described below in accordance with the time series of interactions when the sudden damage occurs as shown in FIG. 4 and a flowchart for handling the sudden damage as shown in FIG. 13.

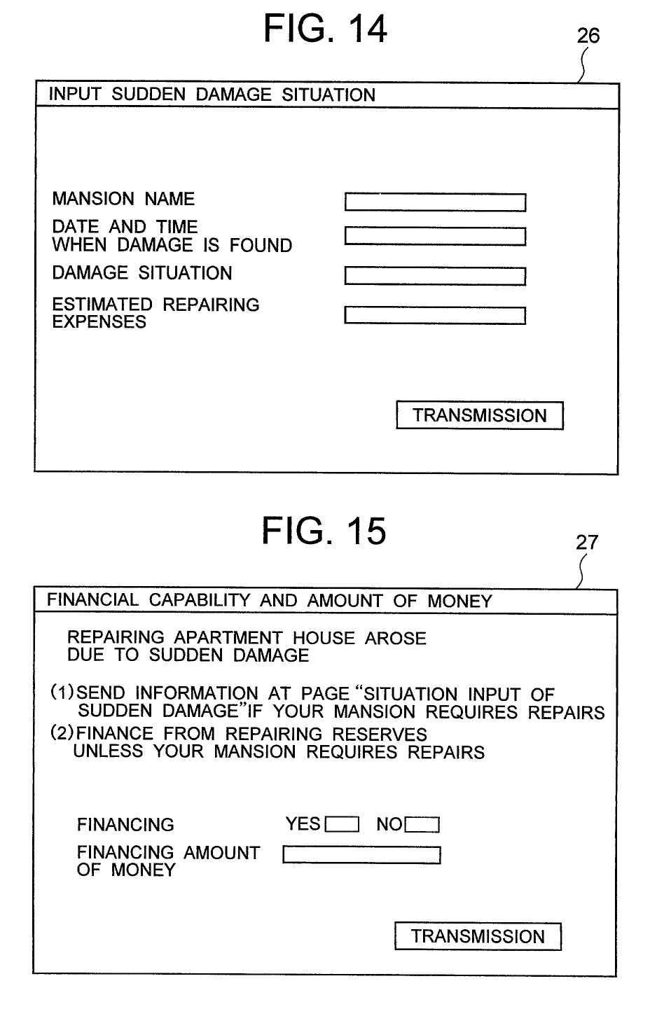

In the case where the comparted owner terminal 5 is connected through the computer network 13 to the repairing reserve collection risk management system 1, the menu screen 22 appears after confirmation of a password. If a sudden damage occurrence button 225 is clicked, a sudden damage situation input screen 26 of FIG. 14 is displayed. If the necessary items are entered into the sudden damage situation input screen 26 and the transmission button is depressed, the occurrence of a damage is notified to the main system 1.

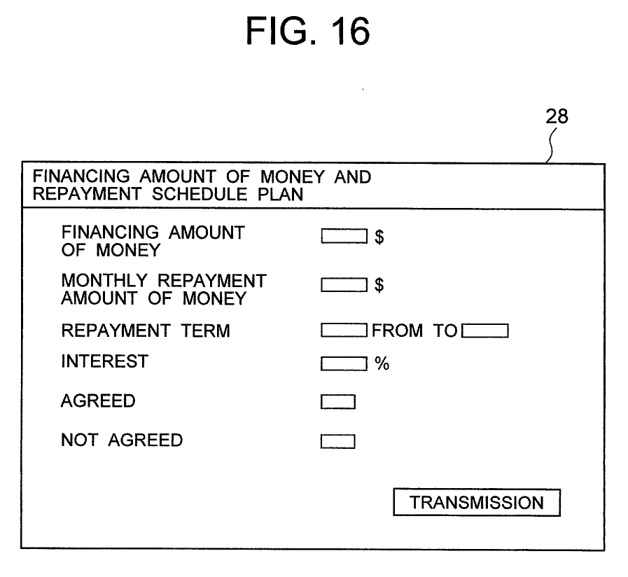

Accepting this notice, the sudden damage handling unit 16 inquires all the caretaker union terminals 6 about the necessity of repairs and financing to the repairing apartment house (S401). In this notice, it is written that necessary items are entered into a financial ability/money amount screen 27 as shown in FIG. 15. The sudden damage handling unit 16 creates a list of caretaker unions requiring repairs and a list of caretaker unions financeable on the basis of the filled contents on the screen 27 entered from each caretaker union terminal 6 (S402). Then, the management company and the financial institution create a financing amount of money and repayment schedule plan, employing the above lists and the main system 1 (S403). In creating the financial amount of money and repayment schedule plan, the caretaker union of the apartment house suffered enables raising funds from the caretaker union of the apartment house not suffered, at a rate of interest lower than the bank lending rates and higher than the bank deposit rates. The financial amount of money and repayment schedule plan is sent from the financial institution terminal 3 to the caretaker union terminal 6 that can finance (S404). This notice involves a financial amount of money and repayment schedule plan screen 28 as shown in FIG. 16. The caretaker union receiving this notice answers on the screen 28 (S405).

The steps S403 to S405 are repeated till all the relevant caretaker unions agree (S406). At a stage of agreement, the sudden damage handling unit 16 notifies the decided financial amount of money and repayment schedule to the financial institution and makes a request for financing (S407). In response to this request, the financial institution 3 notifies the transfer of financed amount of money to the caretaker union suffered.

With this method, when a sudden damage such as an earthquake or the like occurs, the caretaker union of the apartment house suffered enables raising funds for repairing the sudden damage from the caretaker union of the apartment house not suffered, at a rate of interest lower than the bank lending rates and higher than the bank deposit rates.

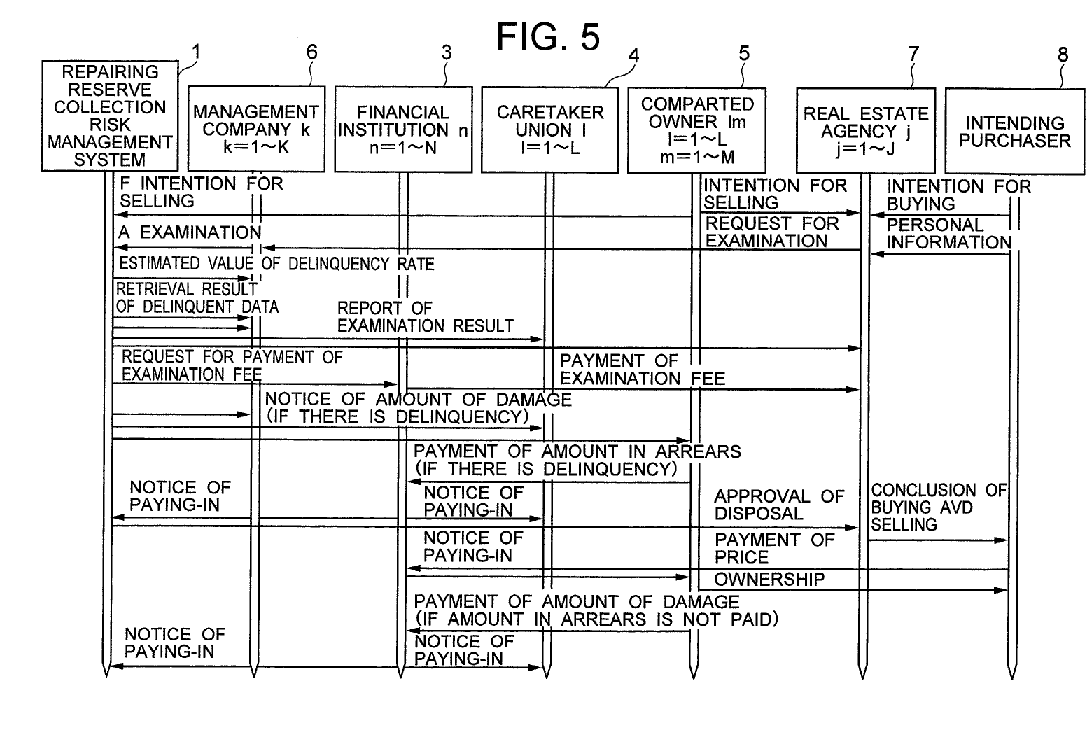

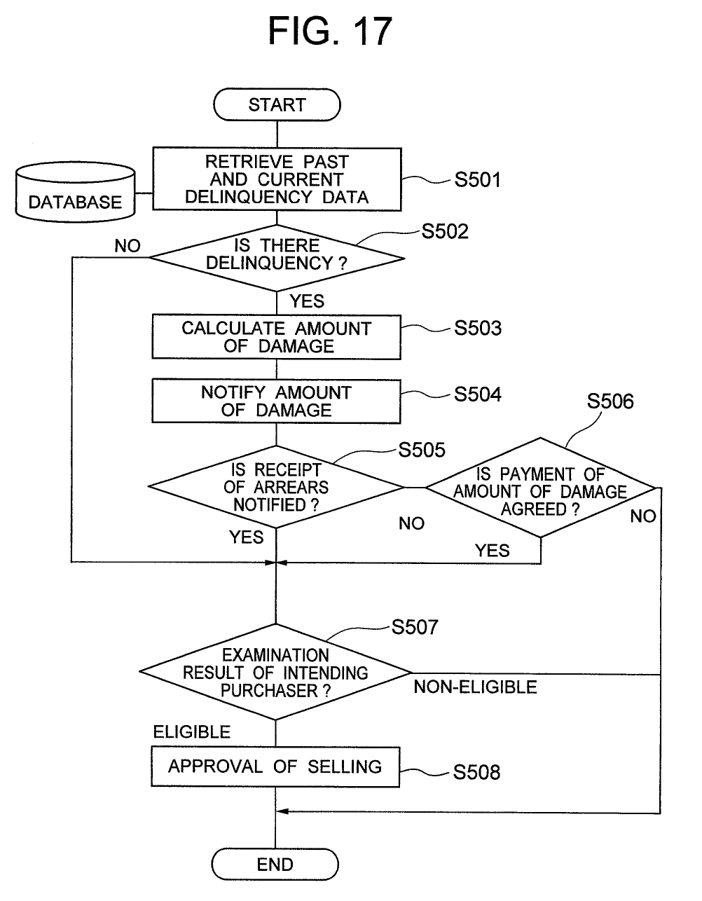

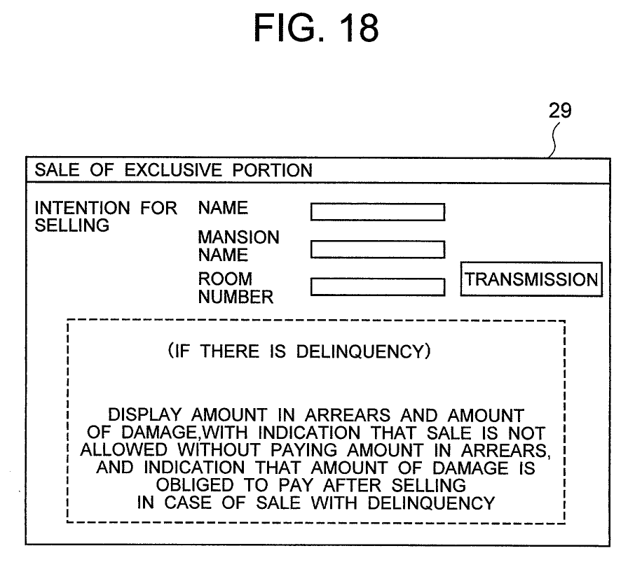

Lastly, the risk management at the time of selling the exclusive portion will be described below in accordance with the time series of interactions for selling the exclusive portion via the mediation of the real estate agent as shown in FIG. 5 and a flowchart of selling the exclusive portion as shown in FIG. 17. In the case where the comparted owner terminal 5 is connected through the computer network 13 to the repairing reserve collection risk management system 1, an exclusive portion selling screen 29 of FIG. 18 appears after confirmation of a password. If the comparted owner inputs a selling intention on the screen 29, the reserve manager 14 retrieves the database 12, and checks whether or not there is a delinquency in the repairing reserve of the comparted owner 5 who wants to sell (S501). If there is delinquency, the amount of damage L that the delinquent pays in selling the occupied portion is calculated in the following manner (S503).

L=max[p−V, D] (7)

Where p is a sale price, V is an evaluated market price for the occupied portion, and D is an amount in arrears.

Further, the evaluated market price V for the occupied portion is calculated as the current value of cash-in when a remnant of the occupied portion is leased.

Numerical expression 6

$$V = {\sum }_{i = 1}^{i \_max} \frac{I}{1 + {r}_{i}} \qquad ( 8 )$$

Where I is a lease charge, r is a rate of interest, and i_max is a remnant of the occupied portion, which are indefinite factors for calculating the evaluated market price.

That is, when the comparted owner who is delinquent sells an exclusive portion, the amount of money that is the sale price subtracted by the evaluated market price at the time of selling and a sum of the amount in arrears and the penalty are compared, whereby a larger amount of money is taken as the amount of damage.

And on the screen 29, the amount in arrears and the amount of damage are displayed, with an indication that the sale is not allowed without paying any amount in arrears, and an indication that the amount of damage is obliged to pay after selling in case of the sale with the delinquency (S504).

In the case where the sum of the amount in arrears and the penalty before selling is paid, the procedure can go to the next step of examination of the intending purchaser even without paying the amount of damage at the time of selling (S505). In the case where the amount in arrears is not paid, the procedure can go to the next step of examination of the intending purchaser (S506), only if it is agreed that the calculated amount of damage is paid after selling.

In this embodiment, the real estate agent mediates, and the intending purchaser 8 is examined like the case of selling a new apartment house in lots. If the result of examination is eligible, the examination/approval unit 15 notifies the sale approval to the real estate agent (S508).

If the purchase and sale is concluded in accordance with the above procedure, the payment of price and the transfer of ownership are conducted in accordance with an ordinary commercial transaction. Finally, when the exclusive portion is sold without paying the amount in arrears, an original comparted owner must pay the amount of damage for the caretaker union 4.

With this method, providing that the evaluated market value of the occupied portion is defined as the current value of a sum of the lease charge foreseen when the remnant of the occupied portion is leased, the method of calculating the amount of damage can be implemented, having a feature that the evaluated market price for the occupied portion is calculated in consideration of indefinite factors including the lease charge, rate of interest, and remnant of occupied portion.

With this invention, the balance of repairing reserves can be managed without any excess and deficiency.

It should be further understood by those skilled in the art that the foregoing description has been made on embodiments of the invention and that various changes and modifications may be made in the invention without departing from the spirit of the invention and the scope of the appended claims.

What is claimed is:

1. A system for managing a balance of a repairing reserve, comprising:
an acquisition unit for acquiring delinquency information indicating a delinquent situation of a repairing reserve to be paid by a comparted owner of an apartment house;
a delinquency rate forecasting unit for forecasting a probability distribution of a delinquency rate on the basis of said delinquency information;
a balance forecasting unit for forecasting the balance of the repairing reserve on the basis of said probability distribution and a foreseen expenditure; and
a judgement unit for judging whether or not a balance of said repairing reserve is within a predetermined proper range.

2. The system for managing a balance of a repairing reserve according to claim 1, further comprising a decision unit for deciding new repairing reserves by changing an amount of the repairing reserve paid by a comparted owner, if the balance of said repairing reserve is not within the proper range, as a result of judgement by said judgement unit.

3. The system for managing a balance of a repairing reserve according to claim 2, further comprising a change time forecasting unit for forecasting the time till the balance of said repairing reserve gets out of the proper range, if the balance of said repairing reserve is within the proper range, as a result of judgement by said judgement unit.

4. The system for managing a balance of a repairing reserve according to claim 2, further comprising an output unit for outputting information for explaining a way of changing the delinquency information or the amount of repairing reserve in response to an inquiry from other apparatus.

5. The system for managing a balance of a repairing reserve according to claim 3, further comprising an output unit for outputting information for explaining a way of changing the delinquency information or the amount of repairing reserve in response to an inquiry from other apparatus.

6. A system for managing a balance of a repairing reserve, comprising:
an acceptance unit for accepting delinquency information indicating a delinquent situation of a repairing reserve to be paid by a comparted owner of an apartment house;
a first forecasting unit for forecasting an average delinquency rate and its standard deviation on the basis of said delinquency information;
a second forecasting unit for forecasting a cumulative delinquent amount on the basis of said average delinquency rate and said standard deviation multiplied by a predetermined factor;
a first calculation unit for calculating a tolerance of said predetermined factor under a constraint that said cumulative reserve is not below an expenditure;
a second calculation unit for calculating a probability that said predetermined factor is within said tolerance; and
a decision unit for deciding the change of a repairing reserve amount if said probability is beyond a predetermined threshold.

7. A recording medium for storing a computer program,
wherein said computer program comprises the steps of:
acquiring delinquency information indicating a delinquent situation of a repairing reserve to be paid by a comparted owner of an apartment house;
forecasting a probability distribution of a delinquency rate on the basis of said delinquency information;
forecasting the balance of the repairing reserve on the basis of said probability distribution and a foreseen expenditure; and
judging whether or not a balance of said repairing reserve is within a predetermined proper range.

8. A computer program making a computer perform the processings of:
acquiring delinquency information indicating a delinquent situation of a repairing reserve to be paid by a comparted owner of an apartment house;
forecasting a probability distribution of a delinquency rate on the basis of said delinquency information;
forecasting the balance of a repairing reserve on the basis of said probability distribution and a foreseen expenditure; and
judging whether or not a balance of said repairing reserve is within a predetermined proper range.
